(19) United States
(12) Patent Application Publication
(10) Pub. No.: US 2020/0241460 A1
(43) Pub. Date: Jul. 30, 2020

(54) IMAGE FORMING APPARATUS AND IMAGE FORMING METHOD

(71) Applicant: Oki Data Corporation, Tokyo (JP)

(72) Inventor: Kohei KIGAWA, Tokyo (JP)

(73) Assignee: Oki Data Corporation, Tokyo (JP)

(21) Appl. No.: 16/687,054

(22) Filed: Nov. 18, 2019

(30) Foreign Application Priority Data
Jan. 25, 2019 (JP) 2019-11395

(51) Int. Cl. G03G 15/00; G03G 15/16; G03G 15/01

(52) U.S. Cl. CPC G03G 15/6585; G03G 15/0178; G03G 15/161

(57) ABSTRACT

An image forming apparatus includes: a first image forming unit that forms a clear toner image with a clear toner; a second image forming unit that forms a color toner image with a color toner; a transfer unit that transfers at least one of the clear toner image and the color toner image onto a medium; and a controller that controls formation of the clear toner image and the color toner image. When the medium is a heat transfer medium and the color toner image is formed on the heat transfer medium, the controller performs control so that the clear toner image is formed on a region where the color toner image is formed and a weight per unit area of the color toner is less than 0.29 mg/cm², and a weight per unit area of the clear toner image is 0.15 to 0.55 mg/cm².

### BACKGROUND OF THE INVENTION

### 1. Field of the Invention

The present invention relates to an image forming apparatus and an image forming method, and is preferably applied to an electrophotographic printer, for example.

### 2. Description of the Related Art

There have been widely used image forming apparatuses (or printers) that perform printing by forming toner images with toner based on image data supplied from computer apparatuses or the like, transferring the toner images onto media, such as paper, and applying heat and pressure to the toner images to fix them to the media.

In recent years, there have been demands for printing on various media with image forming apparatuses. For example, there has been a demand for printing (or transferring and fixing toner images) on fabric media (also referred to below as special media), such as T-shirts.

However, many image forming apparatuses are configured to transfer toner images from photosensitive drums or the like of image forming units onto media while conveying the media with conveying units including conveying rollers, conveyance guides, and the like. These conveying units are intended to convey media that have some stiffness like paper and have rectangular or elongated shapes. Thus, with such conveying units, it is difficult to smoothly convey media such as fabric, or successfully transfer toner images onto fabric.

Thus, as a method of printing on a medium such as fabric using an image forming apparatus, there has been proposed a method using special heat transfer media called an M sheet and a T sheet (see, e.g., Japanese Patent Application Publication No. 2018-141869). According to this method, first, a toner image is formed and transferred onto an M sheet (also referred to as a heat transfer medium) having an adhesive layer, by an image forming apparatus. Then, the M sheet is placed on a T sheet (also referred to as an intermediate transfer medium) with the toner image facing the T sheet, and heat and pressure are applied thereto by an iron to transfer the toner image and adhesive layer onto the T sheet. Then, the T sheet is placed on a T-shirt with the toner image and adhesive layer facing the T-shirt, and heat and pressure are applied thereto by an iron to transfer the toner image and adhesive layer onto the T-shirt. In this manner, the toner image is fixed to the T-shirt, that is, an image is printed on the T-shirt.

In an image forming apparatus, since toner is powder, color gradation is expressed by increasing or decreasing the amount (referred to below as the toner deposition amount) of toner deposited per unit area. The image forming apparatus can successfully express color gradation of an image, by making the toner deposition amount relatively large in dark portions of the image and making the toner deposition amount relatively small in light portions of the image.

Also, when the image forming apparatus transfers a toner image onto the M sheet, it makes the toner deposition amount relatively small in light portions of the image. Thus, when the toner image is transferred from the M sheet to the T sheet by the iron, in portions where the toner deposition amount is small, the force with which the toner adheres or sticks to the T sheet is insufficient, and part of the toner and adhesive layer may remain on the M sheet and be not transferred onto the T sheet. In such a case, the image finally transferred onto the T-shirt lacks the toner in the light portions and fails to sufficiently express gradation.

### SUMMARY OF THE INVENTION

An object of an aspect of the present invention is to provide an image forming apparatus and an image forming method capable of improving image quality of an image transferred on a special medium.

According to an aspect of the present invention, there is provided an image forming apparatus including: a first image forming unit that forms a clear toner image with a clear toner; a second image forming unit that forms a color toner image with a color toner; a transfer unit that transfers at least one of the clear toner image and the color toner image onto a medium; and a controller that controls formation of the clear toner image and the color toner image, wherein when the medium is a heat transfer medium and the color toner image is formed on the heat transfer medium, the controller performs control so that the clear toner image is formed on a region where the color toner image is formed and a weight per unit area of the color toner is less than 0.29 mg/cm², and a weight per unit area of the clear toner image is 0.15 to 0.55 mg/cm².

According to another aspect of the present invention, there is provided an image forming method comprising: (a) forming a toner image and transferring the toner image onto an adhesive layer of a heat transfer medium, with an image forming apparatus; (b) transferring the toner image and the adhesive layer onto an intermediate transfer medium by applying heat and pressure with a heating and pressing apparatus in a state where the heat transfer medium is placed on the intermediate transfer medium with the toner image therebetween; and (c) transferring the toner image and the adhesive layer onto a special medium by applying heat and pressure with the heating and pressing apparatus in a state where the intermediate transfer medium is placed on the special medium with the toner image and the adhesive layer therebetween, wherein step (a) includes: forming a clear toner image with a clear toner and forming a color toner image with a color toner by means of an image forming unit under control of a controller provided in the image forming apparatus; and transferring at least one of the clear toner image and the color toner image onto the heat transfer medium by means of a transfer unit, and wherein the controller performs control so that the clear toner image is formed on a region where the color toner image is formed and a weight per unit area of the color toner is less than 0.29 mg/cm, and a weight per unit area of the clear toner image is 0.15 to 0.55 mg/cm².

### BRIEF DESCRIPTION OF THE DRAWINGS

In the attached drawings:

FIG. 1 is a schematic diagram illustrating a configuration of an image forming apparatus;

FIGS. 2A to 2C are schematic diagrams illustrating image printing by a special medium printing system according to an embodiment;

FIGS. 3A and 3B are schematic diagrams illustrating configurations of an M sheet and a T sheet, respectively;

FIGS. 4A and 4B are views illustrating surfaces of an adhesive layer;

FIG. 5 is a table showing DSC measurement conditions;

FIG. 6 is a graph showing a result of a DSC measurement of an adhesive layer of an M sheet;

FIGS. 7A and 7B are diagrams showing results of wettability measurements;

FIGS. 8A and 8B are diagrams showing results of wettability measurements of different media;

FIG. 9 is a table showing, for each of fluorescent toners of different colors, toner deposition amounts at print duties;

FIGS. 10A to 10E are schematic diagrams illustrating transfer of a toner image onto media;

FIGS. 11A and 11B are schematic diagrams illustrating toner remaining and toner break, respectively;

FIG. 12 is a table showing results of gradation measurement;

FIG. 13 is a graph showing results of glossiness measurements;

FIG. 14 is a graph showing results of color gamut measurements; and

FIGS. 15A to 15C are schematic diagrams illustrating image printing by a special medium printing system according to another embodiment.

### DETAILED DESCRIPTION OF THE INVENTION

Embodiments of the present invention will now be described with reference to the drawings.

### Configuration of Image Forming Apparatus

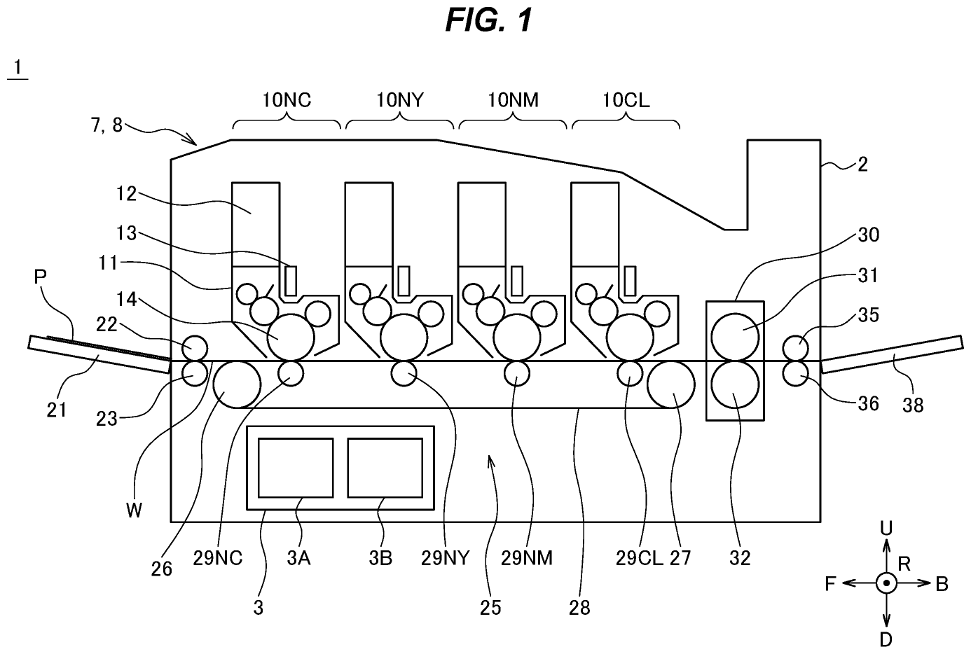

FIG. 1 illustrates an image forming apparatus 1 according to an embodiment. The image forming apparatus 1 is an electrophotographic printer, and capable of forming (or printing) a color image on a sheet (e.g., paper sheet) P as a medium. The image forming apparatus 1 is a single function printer (SFP) having a printer function but having neither an image scanner function of reading a document nor a communication function using telephone lines.

The image forming apparatus 1 includes a substantially box-shaped printer housing 2, in which various components are disposed. The following description assumes that the left end of the image forming apparatus 1 in FIG. 1 is a front side of the image forming apparatus 1, and an up-down direction, a left-right direction, and a front-rear direction are those as viewed toward the front side. In FIG. 1, the rightward, forward, rearward, upward, and downward directions are indicated by arrows R, F, B, U, and D, respectively.

The image forming apparatus 1 includes a controller 3 that entirely controls the image forming apparatus 1. The controller 3 is connected wirelessly or by wire to a host apparatus (not illustrated), such as a computer apparatus. Upon receiving, from the host apparatus, image data representing an image to be printed and a command to print the image data, the controller 3 performs a print process to form a printed image on a surface of a sheet P.

The controller 3 includes multiple functional blocks, including an instruction receiver 3A, an image analyzer 3B, and the like, and implements various functions with the respective functional blocks. When the instruction receiver 3A, serving as a type designation receiver, receives a designation regarding the type of the sheet P through instruction from the host apparatus or instruction through an operation unit 8 (to be described later), it notifies the image analyzer 3B of the designation. The image analyzer 3B analyzes image data received from the host apparatus, and performs predetermined processes, such as density correction, on the basis of an instruction from the host apparatus, an instruction supplied from the instruction receiver 3A, or the like. Then, the image analyzer 3B generates bitmap data for each color and supplies the bitmap data to image forming units 10NC, 10NY, 10NM, and 10CL (to be described later).

The controller 3 may be or include one or more processors or processing circuitry. For example, the controller 3 includes a central processing unit (CPU), a read only memory (ROM), and a random access memory (RAM), and performs various processes by reading and executing predetermined programs. For example, the controller 3 forms the multiple functional blocks and implements the various functions with the respective functional blocks by reading and executing a printing program.

A display 7 and the operation unit 8 are disposed on the front side of an upper surface of the printer housing 2. The display 7, which includes a display device, such as a liquid crystal panel, displays information with characters, images, or the like under control of the controller 3. The operation unit 8, which includes multiple operation buttons, such as direction buttons, an OK button, and a cancel button, receives an operation instruction from a user and notifies the controller 3 of the operation instruction.

A conveying path W, extending generally along the front-rear direction, is formed slightly below the center in the printer housing 2. In the printer housing 2, various components are disposed along the conveying path W. The image forming apparatus 1 forms (or prints) an image on a sheet P while conveying the sheet P along the conveying path W.

The four image forming units 10NC, 10NY, 10NM, and 10CL are arranged in this order from the front side toward the rear side, on the upper side of the printer housing 2 (above the conveying path W). The image forming units 10NC, 10NY, 10NM, and 10CL correspond to colors of fluorescent cyan (NC), fluorescent yellow (NY), fluorescent magenta (NM), and clear (CL), respectively. The image forming units 10NC, 10NY, 10NM, and 10CL form a fluorescent cyan toner image, a fluorescent yellow toner image, a fluorescent magenta toner image, and a clear toner image with fluorescent cyan, fluorescent yellow, fluorescent magenta, and clear toners, respectively. Although the image forming units 10NC, 10NY, 10NM, and 10CL correspond to the different colors, they have the same configuration. Hereinafter, the image forming units 10NC, 10NY, 10NM, and 10CL may be referred to as image forming units 10. The clear (CL) toner is colorless and transparent. The clear (CL) toner is placed on an image of a colored toner to provide the image with gloss, and may be used in other cases.

Each of the image forming units 10 includes an image forming main portion 11, a toner cartridge 12, and a print head 13. A photosensitive drum 14, multiple rollers, such as a developing roller, and the like are disposed in the image forming main portion 11. Each of the photosensitive drum 14 and multiple rollers has a cylindrical shape with a central axis along the left-right direction, and is rotatably supported by the image forming main portion 11. The photosensitive drum 14 abuts the conveying path W in the vicinity of the lower end of the photosensitive drum 14. Some of the multiple rollers are made of conductive materials and applied with predetermined high voltages.

The toner cartridge 12 stores toner as developer and is attached to the upper side of the image forming main portion 11. The toner cartridge 12 supplies the toner stored therein to the image forming main portion 11. The print head 13 includes multiple light emitting elements, such as light emitting diodes (LEDs), arranged along the left-right direction, and emits light as appropriate according to bitmap data supplied from the controller 3.

In the image forming unit 10, when a print process is performed, the photosensitive drum 14, rollers, and the like in the image forming main portion 11 are rotated as appropriate, and the print head 13 is caused to emit light as appropriate while rollers and the like in the image forming main portion 11 are applied with predetermined high voltages. Thereby, the image forming unit 10 forms a toner image on a peripheral surface of the photosensitive drum 14 by using the toner supplied from the toner cartridge 12. At this time, the photosensitive drum 14 rotates, thereby moving the formed toner image to the vicinity of the lower end of the photosensitive drum 14 (or the vicinity of the conveying path W).

A sheet feed tray 21 is disposed on the front side of the printer housing 2. The sheet feed tray 21 is generally in the form of a flat plate shape, and has a generally flat upper surface. The upper surface of the sheet feed tray 21 is inclined with respect to a horizontal direction so that its rear side is slightly lowered. The rear end of the sheet feed tray 21 is at substantially the same height as the conveying path W. The sheet P is placed on the upper side of the sheet feed tray 21 with a print surface, which is a surface to be subjected to printing, of the sheet P facing upward. A plurality of sheets P can be stacked on the sheet feed tray 21.

Registration rollers 22 and 23 are disposed behind the sheet feed tray 21 on the upper and lower sides of the conveying path W, respectively. The registration rollers 22 and 23 each have a cylindrical shape with a central axis along the left-right direction, and their peripheral surfaces abut each other at the conveying path W. The registration rollers 22 and 23 are rotated as appropriate by being supplied with drive force from a motor (not illustrated) and convey sheets P placed on the sheet feed tray 21 one by one rearward while separating them.

The registration rollers 22 and 23 have their rotations controlled as appropriate, correct skew (or inclination of sides) of the sheet P relative to the traveling direction by applying frictional force to the sheet P, place the sheet P in a state where leading and trailing edges of the sheet P are along the left-right direction, and then feed the sheet P rearward.

A transfer conveying unit 25 is disposed behind the registration rollers 22 and 23 and below the conveying path W (or below the four image forming units 10). The transfer conveying unit 25 includes a front conveying roller 26, a rear conveying roller 27, a transfer belt 28, and four transfer rollers 29NC, 29NY, 29NM, and 29CL, which may be referred to as transfer rollers 29.

The front conveying roller 26 has a cylindrical shape with a central axis along the left-right direction, and is disposed in front of and below the image forming unit 10NC so that it abuts or is extremely close to the conveying path W in the vicinity of the upper end of the front conveying roller 26. The rear conveying roller 27 has a cylindrical shape with a central axis along the left-right direction as with the front conveying roller 26, and is disposed behind and below the image forming unit 10CL so that it abuts or is extremely close to the conveying path W in the vicinity of the upper end of the rear conveying roller 27.

The transfer belt 28 is an endless belt made of flexible material, and has a sufficient width in the left-right direction. The transfer belt 28 is stretched around the front conveying roller 26 and rear conveying roller 27. An upper portion of the transfer belt 28 stretched between the front conveying roller 26 and rear conveying roller 27 extends along the conveying path W, and abuts the photosensitive drums 14 of the respective image forming units 10 in the vicinities of the lower ends of the photosensitive drums 14.

Each of the transfer rollers 29 has a cylindrical shape with a central axis along the left-right direction, as with the front conveying roller 26 or the like. The transfer rollers 29NC, 29NY, 29NM, and 29CL are respectively disposed under the image forming units 10NC, 10NY, 10NM, and 10CL between the front conveying roller 26 and the rear conveying roller 27. Each transfer roller 29 is urged upward and abuts the transfer belt 28 in the vicinity of the upper end of the transfer roller 29. Each transfer roller 29 sandwiches the transfer belt 28 with the photosensitive drum 14 of the corresponding image forming unit 10, on the conveying path W. The transfer rollers 29 are applied with predetermined high voltages, as with the rollers of the image forming units 10.

The transfer conveying unit 25 rotates the front conveying roller 26, rear conveying roller 27, and transfer rollers 29 as appropriate, thereby moving the transfer belt 28 around the front conveying roller 26 and rear conveying roller 27 and moving the transfer belt 28 in the rear direction (also referred to below as the conveying direction) on the conveying path W. At this time, when the transfer conveying unit 25 is supplied with a sheet P from the registration rollers 22 and 23, it sandwiches the sheet P and the transfer belt 28 between the photosensitive drums 14 of the respective image forming units 10 and the transfer rollers 29 and conveys the sheet P rearward along the conveying path W. Further, when toner images are formed by the image forming units 10, they are transferred from the peripheral surfaces of the photosensitive drums 14 onto the upper surface (i.e., print surface) of the sheet P.

In the image forming apparatus 1, a sheet P is conveyed rearward along the conveying path W, toner images of the respective colors (i.e., a fluorescent cyan toner image, a fluorescent yellow toner image, a fluorescent magenta toner image, and a clear toner image) are sequentially transferred from the image forming units 10NC, 10NY, 10NM, and 10CL onto the sheet P. Thus, if toner images are transferred from the image forming units 10 onto the same position of the sheet P, toners of fluorescent cyan (NC), fluorescent yellow (NY), fluorescent magenta (NM), and clear (CL) are sequentially stacked on the print surface. Hereinafter, for convenience of description, fluorescent cyan toner images, fluorescent yellow toner images, and fluorescent magenta toner images may be referred to as color toner images.

A fixing unit 30 is disposed behind the image forming unit 10CL and transfer conveying unit 25. The fixing unit 30 includes a heating roller 31 and a pressure roller 32 that are disposed to face each other with the conveying path W therebetween. The heating roller 31 has a cylindrical shape with a central axis along the left-right direction and is provided with a heater therein. The pressure roller 32 has a cylindrical shape as with the heating roller 31 and presses its upper surface against a lower surface of the heating roller 31 with a predetermined pressing force.

The fixing unit 30 heats the heating roller 31 and rotates the heating roller 31 and pressure roller 32 in predetermined directions under control of the controller 3. Thereby, the fixing unit 30 applies heat and pressure to a sheet P (or a sheet P on which toner images of the respective colors have been transferred in a superimposed manner) conveyed from the transfer conveying unit 25 to fix the toner, and further conveys the sheet P rearward.

Discharging rollers 35 and 36 are disposed behind and slightly above the fixing unit 30. Each of the discharging rollers 35 and 36 has a cylindrical shape with a central axis along the left-right direction, and their peripheral surfaces abut each other at the conveying path W. The discharging rollers 35 and 36 are rotated as appropriate under control of the controller 3, thereby conveying rearward and upward the sheet P conveyed from the fixing unit 30 to discharge the sheet P onto a sheet discharge tray 38 disposed on the rear side of the printer housing 2.

### 2. Composition of Toner

Next, a composition of each fluorescent toner will be described. Each fluorescent toner includes toner base particles containing at least a binder resin, and one or more external additives, such as an inorganic powder or an organic powder, added to the toner base particles. The binder resin is added with one or more release agents, one or more colorants, and the like. In addition, the binder resin may be added with one or more additives, such as a fluorescent brightener, a charge control agent, a conductivity conditioner, a flow improver, or a cleaning property improver, as appropriate. The binder resin may be a mixture of multiple types of resins. In this embodiment, multiple amorphous polyester resins and a crystalline polyester resin having a crystal structure are used as the binder resin.

Examples of the release agents include, but are not limited to, aliphatic hydrocarbon waxes, such as low-molecular weight polyethylene, low-molecular weight polypropylene, olefin copolymer, microcrystalline wax, paraffin wax, and Fischer-Tropsch wax; oxides of aliphatic hydrocarbon waxes, such as polyethylene oxide; block copolymers thereof; waxes consisting primarily of fatty acid esters, such as carnauba wax and montanoic acid ester wax; waxes obtained by deoxidizing part or the whole of fatty acid ester, such as deoxidized carnauba wax; and other known waxes. It is effective that the content of the release agents in the toner is 0.1 to 20 parts by weight, preferably 0.5 to 12 parts by weight, based on 100 parts by weight of the binder resin. It is also preferable to use multiple waxes.

As the colorants, dyes and pigments used as colorants for conventional black, yellow, magenta, and cyan toners may be used alone or in combination. Further, special-purpose pigments, such as fluorescent pigments, fluorescent brighteners, and magnetic pigments, may be used as the colorants. In this embodiment, toners containing fluorescent pigments or fluorescent brighteners, specifically fluorescent yellow (NY), fluorescent magenta (NM), and fluorescent cyan (NC) toners (referred to below as fluorescent toners), are used as colored toners. The content of the colorants in the toner is 2 to 25 parts by weight, preferably 2 to 15 parts by weight, based on 100 parts by weight of the binder resin.

Examples of the colorants of the fluorescent yellow (NY) toner include, but are not limited to, SX-100 series and SX-1000 series (manufactured by SINLOIHI CO., LTD.). SX-100 series includes SX-105 Lemon Yellow, SX-106 Orange Yellow, and the like. SX-1000 series includes SX-1005 Lemon Yellow and the like.

Examples of the colorants of the fluorescent magenta (NM) toner include, but are not limited to, SX-100 series and SX-1000 series (manufactured by SINLOIHI CO., LTD.). SX-100 series includes SX-101 Red Orange, SX-103 Red, SX-104 Orange, SX-117 Pink, SX-127 Rose, and the like. SX-1000 series includes SX-1004 Orange, SX-1007 Pink, SX-1037 Magenta, and the like.

Examples of the colorants of the fluorescent cyan (NC) toner include, but are not limited to, dyes, pigments, and the like used as colorants for conventional cyan toners, and combinations thereof. Specifically, examples of them include phthalocyanine blue, Pigment Green B, Pigment Blue 15:3, and Solvent Blue 35. In addition to these colorants, 2 to 25 parts by weight, preferably 2 to 15 parts by weight, of fluorescent brightener, such as stilbene compounds, coumarin compounds, and biphenyl compounds, may be added to 100 parts by weight of the binder resin to impart fluorescence to the fluorescent cyan toner.

As the charge control agent, known ones may be used. For example, in the case of negatively charged toner, examples of the charge control agent include azo complex charge control agents, salicylate complex charge control agents, and calixarene charge control agents. The content of the charge control agent in the toner is 0.05 to 15 parts by weight, preferably 0.1 to 10 parts by weight, based on 100 parts by weight of the binder resin.

The external additives, which are added to the toner base particles, are added to improve environmental stability, charge stability, developing properties, fluidity, storage properties, or the like. As the external additives, known ones may be used. The content of the external additives is 0.01 to 10 parts by weight, preferably 0.05 to 8 parts by weight, based on 100 parts by weight of the binder resin. The external additives are added at a predetermined ratio in an external addition process, and adhere to the toner base particles. To adjust the fluidity of the toner, 0.5 to 3.0 parts by weight of silica having a size greater than 50 nm may be added as an external additive.

The clear toner is, for example, a toner containing toner base particles produced by a dissolution suspension method. This type of clear toner contains toner base particles produced by mixing an oil phase prepared by dissolving and/or dispersing at least a binder resin and one or more additives in an organic solvent and an aqueous phase prepared by dispersing inorganic particles as a dispersant in an aqueous solvent to obtain a suspension containing oil phase droplets with the inorganic particles adhering to their surfaces, and then removing the solvent and removing the inorganic particles by adding an acid.

Examples of the binder resin used in the clear toner include, but are not limited to, homopolymers of monomers, such as styrenes, such as styrene, parachlorostyrene, and a-methylstyrene, esters having a vinyl group, such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate, vinyl nitriles, such as acrylonitrile and methacrylonitrile, vinyl ethers, such as vinyl methyl ether and vinyl isobutyl ether, vinyl ketones, such as vinyl methyl ketone, vinyl ethyl ketone, and vinyl isopropenyl ketone, polyolefins, such as ethylene, propylene, and butadiene; copolymers obtained by combining two or more of the monomers; and mixtures thereof. Further, examples of the binder resin include non-vinyl condensed resins, such as epoxy resins, polyester resins, polyurethane resins, polyamide resins, cellulosic resins, and polyether resins; mixtures of these and vinyl resins; and graft polymers obtained by polymerizing vinyl monomers in the presence of these.

In this embodiment, a polyester resin is used as the binder resin of the clear toner. The polyester resin as the binder resin preferably has a glass transition point (Tg) of 61.4° C. or more and 63.1° C. or less, and a ½ method melting temperature of 106.0° C. or more and 109.6° C. or less.

The polyester resin as the binder resin is a polyester resin modified with a long-chain alkyl group represented by the following formula (1) to improve the hydrophobicity of the polyester resin:

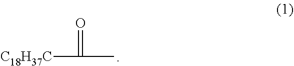

The polyester resin modified with the long-chain alkyl group represented by formula (1) can be prepared by condensation polymerization of an alcohol component and a carboxylic acid component. The clear toner of the embodiment can use a polyester obtained by condensation polymerization of an alcohol component and a carboxylic acid component.

Examples of the alcohol component include dihydric or higher alcohols, such as ethylene glycol, diethylene glycol, triethylene glycol, polyethylene glycol, propylene glycol, butanediol, pentanediol, hexanediol, cyclohexane dimethanol, xylene glycol, dipropylene glycol, polypropylene glycol, bisphenol A, hydrogenated bisphenol A, bisphenol A ethylene oxide, bisphenol A propylene oxide, sorbitol, and glycerin, alcohol derivatives, and the like.

Examples of the carboxylic acid component include di-or higher carboxylic acids and carboxylic acid derivatives, such as maleic acid, fumaric acid, phthalic acid, isophthalic acid, terephthalic acid, succinic acid, adipic acid, trimellitic acid, pyromellitic acid, cyclopentane dicarboxylic acid, succinic anhydride, trimellitic anhydride, maleic anhydride, and dodecenyl succinic anhydride, and the like.

Each of the alcohol component and carboxylic acid component may be a combination of two or more materials.

As the organic solvent used in preparing the oil phase, common organic solvents may be used. Examples of the organic solvent include esters, such as methyl acetate, ethyl acetate, and butyl acetate. The examples of the organic solvent also include hydrocarbons, such as toluene and xylene, halogenated hydrocarbons, such as methylene chloride, chloroform, and dichloroethane, alcohols, such as methanol and ethanol, ketones, such as acetone, methyl ethyl ketone, and cyclohexanone, and the like. The organic solvent may be a mixture of two or more solvents.

As the aqueous medium for preparing the aqueous phase, water is mainly used. The aqueous medium may be a mixture of water with a water-soluble solvent. As a suspension stabilizer serving as the dispersant, inorganic particles may be used. Examples of the suspension stabilizer include tricalcium phosphate, hydroxyapatite, calcium carbonate, titanium oxide, aluminum hydroxide, magnesium hydroxide, barium sulfate, silica, and the like. As the external additives, inorganic particles (e.g., silicon dioxide or titanium dioxide) are used.

A fluorescent cyan (NC) toner, a fluorescent yellow (NY) toner, a fluorescent magenta (NM) toner, and a clear toner used in the image forming apparatus 1 were prepared.

The volume median diameter D₅₀ of each of the toners was measured. The volume median diameter D₅₀ refers to the particle diameter at which the cumulative volume percentage is 50%. Here, the volume median diameter D₅₀ was measured using a cell counter and analyzer (Coulter Multisizer III, manufactured by Beckman Coulter, Inc.) under the measurement conditions that the aperture diameter was 100 μm, and the number of measured particles was 30000.

The volume median diameter D₅₀ was measured as follows. First, polyoxyethylene lauryl ether (EMULGEN 109P, manufactured by Kao Corporation) was dissolved in electrolyte (ISOTON II, manufactured by Beckman Coulter, Inc.), so that a dispersion liquid having a concentration of EMULGEN 109P of 5 wt % was prepared. Then, 10 mg of the toner was added to 5 ml of the dispersion liquid and dispersed with an ultrasonic disperser for one minute. Then, the dispersion liquid was added with 25 ml of the electrolyte, and further dispersed with the ultrasonic disperser for one minute, so that a toner dispersion liquid was prepared. Then, the prepared toner dispersion liquid was added to 100 ml of the electrolyte placed in the cell counter and analyzer, and the volume median diameter D₅₀ was measured.

The measurements of the volume median diameters D₅₀ of the respective toners showed that the particle diameter of the fluorescent cyan (NC) toner was 7.25 μm, the particle diameter of the fluorescent yellow (NY) toner was 7.49 μm, the particle diameter of the fluorescent magenta (NM) toner was 7.50 μm, and the particle diameter of the clear toner was 7.87 μm.

Next, the melting temperature T1/2 of each of the toners was measured using a flow tester (CFT-500, manufactured by Shimadzu Corporation) as follows. Under the conditions of a load of 10 kg and a die hole diameter of 1 mm, 1 g of the toner in the form of a pellet was heated from a start temperature of 50° C. at a temperature rising rate of 3° C./min. The amount of descent of the plunger of the flow tester was plotted with respect to the temperature, and the temperature at which half of the toner was flowed out was determined as the melting temperature T1/2.

The measurements of the melting temperatures T1/2 showed that the melting temperature of the fluorescent cyan (NC) toner was 128.1° C., the melting temperature of the fluorescent yellow (NY) toner was 127.8° C., the melting temperature of the fluorescent magenta (NM) toner was 136.5° C., and the melting temperature of the clear toner was 97.3° C.

The measurement results show that the melting temperature of the clear toner is lower than those of the fluorescent toners, and the clear toner melts more easily than the fluorescent toners. This shows that, for example, when fluorescent toner images and a clear toner image are transferred onto a sheet P in the image forming apparatus 1 and heated by the fixing unit 30 (see FIG. 1) at a temperature above about 130° C. at which the fluorescent toners are melted, the clear toner is also melted.

The amount of toner deposited on (or adhering to) a medium, such as a sheet P, which will be referred to as the toner deposition amount, is represented by the weight (mg) per unit area (1 cm²), and its unit is mg/cm². The toner deposition amount is measured by the following method.

A metal jig including a planar portion including a portion having an area of 1 cm² is prepared. A piece of double-sided tape is attached to the 1 cm² portion of the jig. The weight Wj0 of the jig in this state is measured using an electric balance (CPA225D, manufactured by Sartorius). Then, a direct-current voltage of +300 V is applied to the jig by using an external power source. Then, a medium on which a toner image whose toner deposition amount is to be measured is transferred is prepared, and toner on the medium is taken by pressing once the jig to a substantially center portion of the medium. Then, the weight Wj1 of the jig with the toner adhering thereto is measured using the electric balance. Then, the weight Wt of the toner adhering to the jig is calculated by subtracting the weight Wj0 from the weight Wj1. The measurement of the weight Wt is performed five times, and the average of the weights Wt is calculated. The toner deposition amount (mg/cm²) is calculated by converting the calculated average to a value per unit area.

### 3. Configurations of Special Medium Printing System and Media

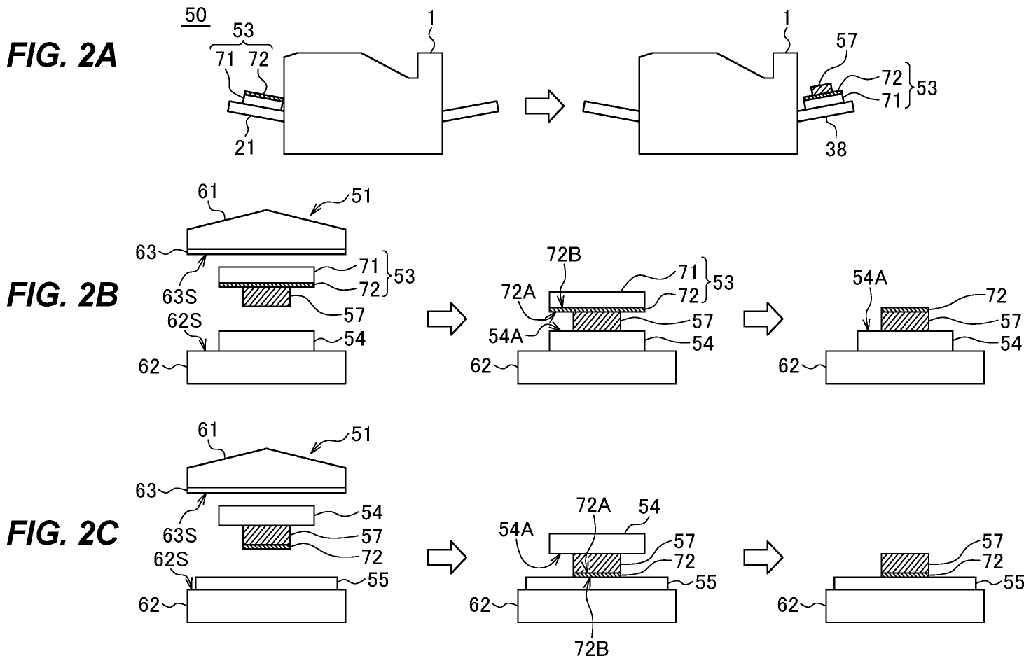

Next, image formation or printing by a special medium printing system 50 will be described. As illustrated in FIGS. 2A, 2B, and 2C, the special medium printing system 50 includes the image forming apparatus 1 described above and an ironing and pressing apparatus 51, and an M sheet 53, a T sheet 54, and a special medium 55 are used as media.

### 3-1. Configuration of Ironing and Pressing Apparatus

The ironing and pressing apparatus 51, serving as a heating and pressing apparatus, may be, for example, an HTP 234 PS1 (manufactured by The Magic Touch). As illustrated in FIGS. 2B and 2C, the ironing and pressing apparatus 51 includes an iron upper portion 61 on the upper side and an iron lower portion 62 on the lower side.

The iron upper portion 61 includes, in its lower portion, a heat source 63. The heat source 63 has a flat-shaped heating surface 63S as a lower surface and is configured to emit heat. The ironing and pressing apparatus 51 is configured so that the degree of heating by the heat source 63 can be controlled to regulate the heating surface 63S at a desired temperature. The iron lower portion 62 has an upper surface 62S on which media are to be placed. The upper surface 62S is flat.

The ironing and pressing apparatus 51 further includes a moving mechanism (not illustrated) configured to move the iron upper portion 61 in the up-down direction relative to the iron lower portion 62 with the heating surface 63S of the heat source 63, which is a lower surface of the iron upper portion 61, facing the upper surface 62S of the iron lower portion 62. Thus, the ironing and pressing apparatus 51 can move the iron upper portion 61 upward away from the iron lower portion 62 or press the iron upper portion 61 against the iron lower portion 62. The ironing and pressing apparatus 51 is also configured so that the pressure of the iron upper portion 61 against the iron lower portion 62 can be set to a desired value.

### 3-2. Configurations of Media

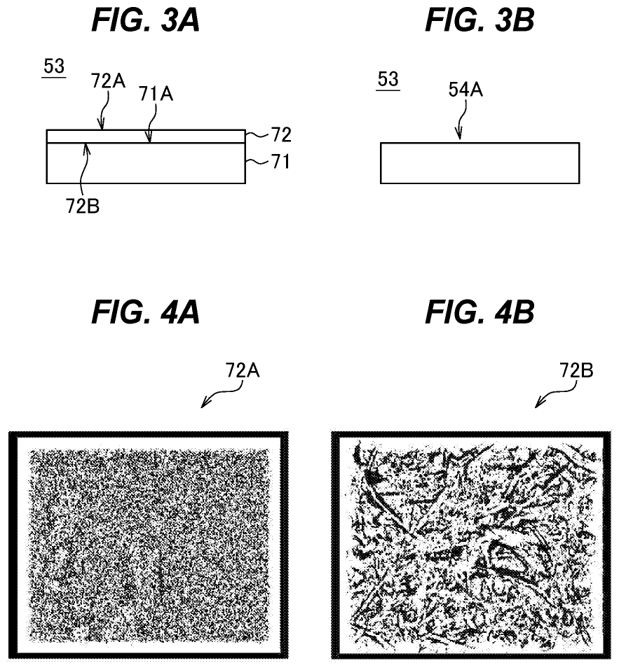

The M sheet 53, serving as a heat transfer medium, is a medium manufactured by The Magic Touch. FIG. 3A is a schematic side view of the M sheet 53. As illustrated in FIG. 3A, the M sheet 53 includes a paper substrate 71 and an adhesive layer 72 laminated on the paper substrate 71. The M sheet 53 has a thickness of about 120.5 μm; the paper substrate 71 has a thickness of about 80.5 μm, and the adhesive layer 72 has a thickness of about 40.0 μm.

The paper substrate 71, serving as a substrate, is made of paper. The paper substrate 71 is relatively thick and has sufficient stiffness. The paper substrate 71 has a surface (referred to below as the release surface 71A) that is an upper surface in FIG. 3A and on which the adhesive layer 72 is laminated. The release surface 71A is coated with a grease material (also referred to below as a release agent) to enhance the release properties. Thus, similarly to paper substrates of common label papers, the paper substrate 71 is configured to allow the adhesive medium to be easily released therefrom.

The adhesive layer 72 is made of an adhesive material. The adhesive layer 72 has an abutment surface 72B that is a lower surface in FIG. 3A and abuts the release surface 71A of the paper substrate 71, and a toner transfer surface 72A that is an upper surface in FIG. 3A and on which a toner image is to be transferred. This will be described in detail later. For convenience of description, hereinafter, the toner transfer surface 72A will also be referred to as the transfer surface of the M sheet 53, and the abutment surface 72B will also be referred to as the substrate abutment surface.

The toner transfer surface 72A and abutment surface 72B of the adhesive layer 72 were observed and photographed using an optical microscope. FIG. 4A illustrates the resulting image of the toner transfer surface 72A, and FIG. 4B illustrates the resulting image of the abutment surface 72B. FIGS. 4A and 4B illustrate images obtained by converting photographed color images into monochrome images by performing a binarization process or the like on the color images. These images show that the toner transfer surface 72A is relatively smooth and the abutment surface 72B is relatively rough, that is, the abutment surface 72B has a larger surface roughness than the toner transfer surface 72A.

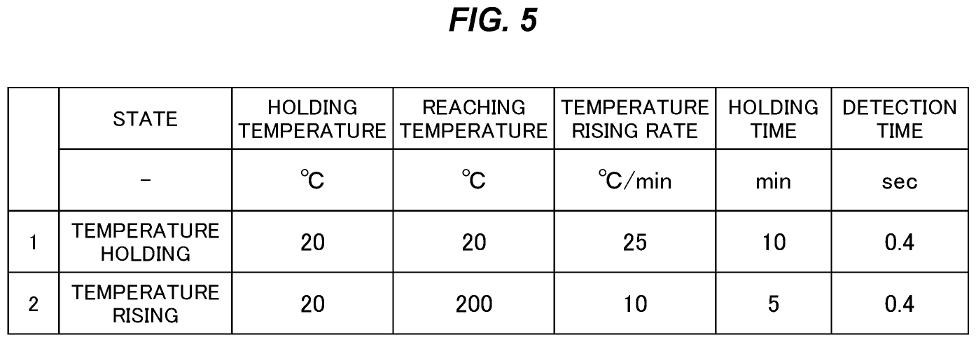

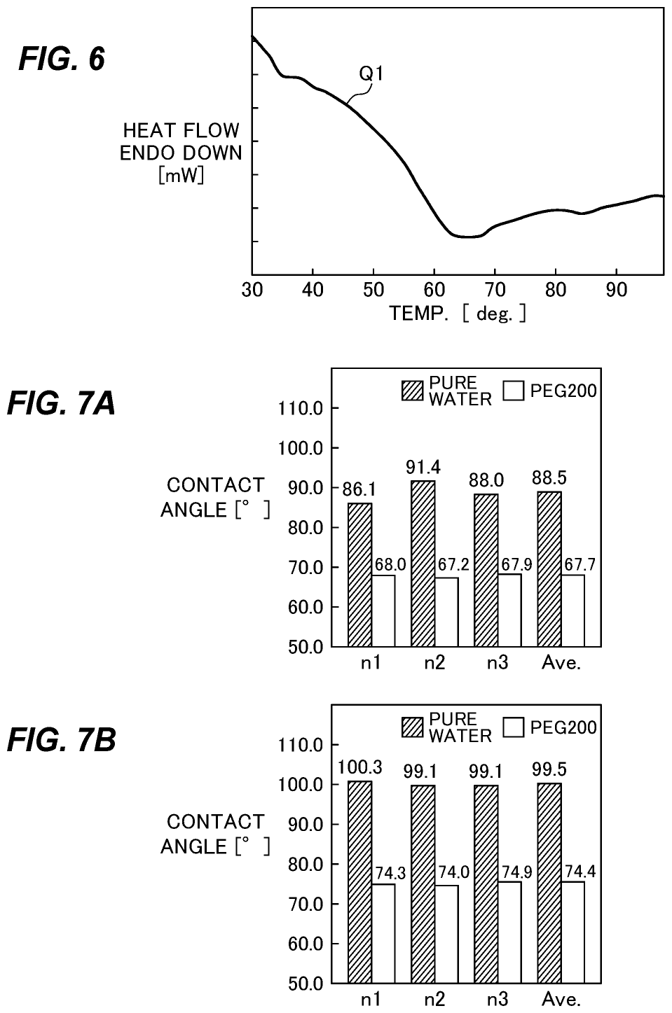

Differential scanning calorimetry (DSC) thermal properties of the adhesive layer 72 were measured using a thermal analyzer system (DSC6220, manufactured by Seiko Instruments Inc.) according to the measurement conditions shown in FIG. 5. FIG. 6 illustrates a characteristic curve Q1 resulting from the measurement. The characteristic curve Q1 has an endothermic peak near 65° C. This shows that the adhesive layer 72 includes a substance whose molecular structure is changed by heating.

The wettability of the adhesive layer 72 was measured using three samples n1, n2, and n3 of the adhesive layer 72. As shown in FIG. 7A, their contact angles with pure water were 86.1 to 91.4°, and their contact angles with polyethylene glycol 200 (referred to below as PEG 200) were 67.2 to 68.0°. From this, it is inferred that the adhesive layer 72 is a lipophilic material.

The T sheet 54 (see FIG. 2B), serving as an intermediate transfer medium, is a medium manufactured by The Magic Touch, as with the M sheet 53. FIG. 3B is a schematic side view of the T sheet 54. As illustrated in FIG. 3B, the T sheet 54 is made of a substantially uniform material. The wettability of a surface 54A of the T sheet 54 was measured using three samples n1, n2, and n3 of the T sheet 54. As shown in FIG. 7B, their contact angles with pure water were 99.1 to 100.3°, and their contact angles with PEG 200 were 74.0 to 74.9°. Thus, the surface 54A of the T sheet 54 has lower hydrophilicity and lipophilicity than the adhesive layer 72 of the M sheet 53. From this, it is thought that a release layer may be formed on the surface 54A of the T sheet 54 by coating the surface 54A with a release agent.

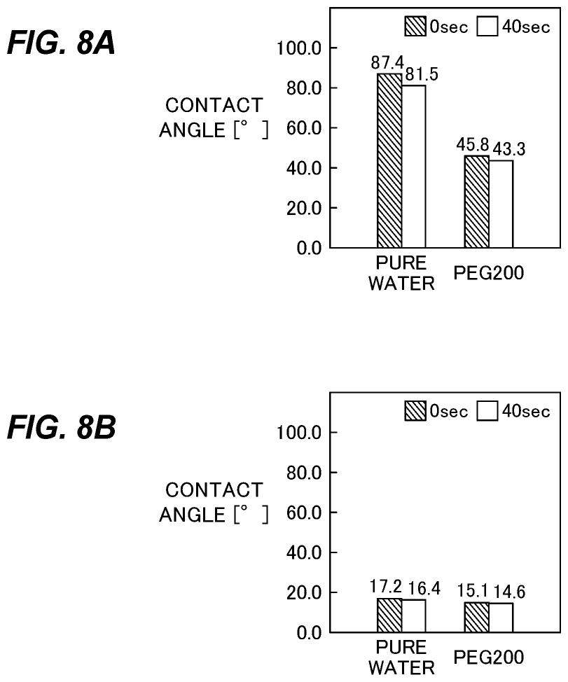

The wettability of a typical printing paper sheet and an overhead projector (OHP) sheet, which is a transparent sheet made of resin, was also measured using pure water and PEG 200. FIG. 8A shows the measurement results of the printing paper sheet, and FIG. 8B shows the measurement results of the OHP sheet. Here, the printing paper sheet was an A4-size sheet of Excellent White (manufactured by Oki Data Corporation), and the OHP sheet was an A4-size OHP film of CG3500 (manufactured by 3M Company). Also, the contact angles were each measured at times of 0 and 40 s.

These measurement results show that the T sheet 54 has generally the same hydrophilicity as the printing paper sheet but has significantly lower lipophilicity than the printing paper sheet. They also show that the T sheet 54 has significantly lower hydrophilicity and lipophilicity than the OHP sheet.

The special medium 55 (see FIG. 2C) is, for example, fabric, such as a T-shirt. The special medium 55 has a larger thickness, larger surface roughness, and significantly lower stiffness than common printing paper. Thus, it is extremely difficult to convey the special medium 55 along the conveying path W in the image forming apparatus 1, and it is practically impossible to transfer a toner image directly onto the special medium 55 by the image forming apparatus 1.

### 3-3. Printing Process

Next, a procedure of a printing process by the special medium printing system 50 will be described in detail with reference to FIGS. 2A to 2C. The printing process by the special medium printing system 50 is roughly divided into an image forming step of forming an image, a first transfer step of performing a first transfer process, and a second transfer step of performing a second transfer process.

First, in the image forming step, as illustrated in FIG. 2A, the image forming apparatus 1 of the special medium printing system 50 performs a print process. Specifically, the image forming apparatus 1 forms a toner image 57 and transfers the toner image 57 onto an M sheet 53 as a sheet P. At this time, the M sheet 53 is placed on the sheet feed tray 21 with the transfer surface (or the surface on which the adhesive layer 72 is laminated) facing upward, and subjected to the print process by the image forming apparatus 1.

Thereby, the toner image 57 is transferred on the toner transfer surface 72A of the adhesive layer 72 of the M sheet 53 and adheres to the adhesive layer 72. Thus, on the transfer surface side of the M sheet 53, the toner image 57 is placed on the adhesive layer 72 in the form of a layer.

Then, in the first transfer step, as illustrated in FIG. 2B, the ironing and pressing apparatus 51 of the special medium printing system 50 transfers the toner image 57 from the M sheet 53 to a T sheet 54. Specifically, in the ironing and pressing apparatus 51, the T sheet 54 is placed on the upper surface 62S of the iron lower portion 62, and the M sheet 53 is placed on the T sheet 54 with the transfer surface (i.e., the surface on which the toner image 57 is transferred) facing downward and the toner image 57 facing the surface 54A of the T sheet 54.

In this state, the ironing and pressing apparatus 51 starts a press process of pressing the iron upper portion 61 against the iron lower portion 62 in a state where the iron upper portion 61 has been heated to a predetermined temperature, and after a lapse of a predetermined time, moves the iron upper portion 61 away from the iron lower portion 62 and completes the press process. Thereby, the toner image 57 adheres to the surface of the T sheet 54 with relatively great force.

Then, in the ironing and pressing apparatus 51, the M sheet 53 located uppermost on the iron lower portion 62 is peeled off the T sheet 54. At this time, the toner image 57 adheres to the surface 54A of the T sheet 54 on the lower side and adheres to the toner transfer surface 72A of the adhesive layer 72 on the upper side. The force with which the lower surface of the toner image 57 adheres to the surface 54A of the T sheet 54 and the force with which the upper surface of the toner image 57 adheres to the toner transfer surface 72A of the adhesive layer 72 are greater than the force with which the abutment surface 72B of the adhesive layer 72 adheres to the paper substrate 71.

Thus, the M sheet 53 is peeled off with the toner image 57 and adhesive layer 72 left on the T sheet 54 in the region in which the toner image 57 is transferred. This places the T sheet 54 in a state where the toner image 57 and adhesive layer 72 are transferred on the surface 54A of the T sheet 54.

Then, in the second transfer step, as illustrated in FIG. 2C, the ironing and pressing apparatus 51 of the special medium printing system 50 transfers the toner image 57 from the T sheet 54 to a special medium 55. Specifically, in the ironing and pressing apparatus 51, the special medium 55 is placed on the upper surface 62S of the iron lower portion 62, and the T sheet 54 is placed on the special medium 55 with the surface 54A (i.e., the surface on which the toner image 57 and adhesive layer 72 are transferred) faces downward and the toner image 57 and adhesive layer 72 facing the special medium 55.

In this state, the ironing and pressing apparatus 51 presses the iron upper portion 61 against the iron lower portion 62 in a state where the iron upper portion 61 has been heated to a predetermined temperature, and after a lapse of a predetermined time, moves the iron upper portion 61 away from the iron lower portion 62. Thereby, the adhesive layer 72 adheres to a surface of the special medium 55 at the abutment surface 72B on the lower side with relatively great force. Also, the adhesive layer 72 continues to adhere to the toner image 57 at the toner transfer surface 72A on the upper side with relatively great force.

Then, in the ironing and pressing apparatus 51, the T sheet 54 located uppermost on the iron lower portion 62 is peeled off the special medium 55. At this time, the force with which the abutment surface 72B of the adhesive layer 72 adheres to the special medium 55 and the force with which the toner transfer surface 72A of the adhesive layer 72 adheres to the toner image 57 are greater than the force with which the toner image 57 adheres to the surface 54A of the T sheet 54.

Thus, the T sheet 54 is peeled off with the toner image 57 and adhesive layer 72 left on the special medium 55. This places the special medium 55 in a state where the adhesive layer 72 and toner image 57 are transferred on the surface of the special medium 55.

In this manner, the special medium printing system 50 can print the image on the special medium 55. Specifically, the special medium printing system 50 can finally transfer and adhere the toner image 57 to the special medium 55 by performing the image forming process and two transfer processes of the toner image 57 by means of the M sheet 53 and T sheet 54.

### 4. Print Quality Measurement

In the special medium printing system 50, the printing process was performed on special media 55 at various conditions, and print quality was measured. Specifically, images were formed on M sheets 53 in the image forming step (see FIG. 2A) by the image forming apparatus 1 at various conditions and finally transferred onto special media 55, and observations, measurements, and the like were performed in terms of the gradation, glossiness, and color gamut of the images printed on the special media 55.

In the print quality measurement, the printing process was performed under the following conditions. In the special medium printing system 50, in the image forming step (see FIG. 2A), the speed (or printing speed) of conveyance of the M sheet 53 in the image forming apparatus 1 (see FIG. 1) was 71 mm/s, and a fixing temperature of the fixing unit 30 was 175° C. The optical density (O.D.) value, measured using an X-Rite 526 (manufactured by X-Rite Inc.), of a toner image formed by the image forming apparatus 1 at a print duty (representing a toner density) of 100% was 1.10 for fluorescent cyan (NC), 0.52 for fluorescent yellow (NY), and 0.95 for fluorescent magenta (NM).

In the special medium printing system 50, in the first transfer step (see FIG. 2B), the temperature of the heating surface 63S of the ironing and pressing apparatus 51 was 140° C., the duration of the press process was 45 s, and the pressure of the press process was 31.4 kPa. Further, in the first transfer step, the M sheet 53 was peeled off the T sheet 54 within 5 s after completion of the press process.

In the special medium printing system 50, in the second transfer step (see FIG. 2C), the temperature of the heating surface 63S of the ironing and pressing apparatus 51 was 135° C., the duration of the press process was 5 s, and the pressure of the press process was 31.4 kPa. Also, in the second transfer step, the special medium 55 was a white T-shirt made of 100% cotton. Further, in the second transfer step, the T sheet 54 was peeled off the special medium 55 after it was allowed to cool for 60 s after completion of the press process.

### 4-1. Gradation Measurement

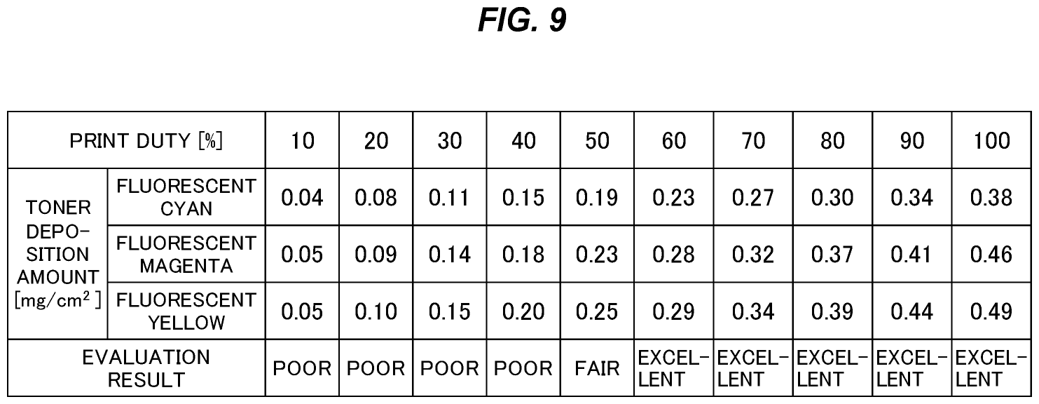

Gradation measurement was performed as described below. First, for each of the fluorescent toners (i.e., the fluorescent cyan (NC) toner, fluorescent yellow (NY) toner, and fluorescent magenta (NM) toner), toner images were formed on media (specifically, the toner transfer surfaces 72A of M sheets 53) at various print duties (i.e., toner densities) varying from 10% to 100% at intervals of 10%, and for each print duty, the toner deposition amount, which was the amount per unit area of the toner deposited on the medium was measured. The results were as shown in FIG. 9.

Next, for each fluorescent toner, images were printed on special media 55 at various conditions as follows.

Toner images were formed on M sheets 53 by forming fluorescent toner images at various print duties varying from 10% to 100% at intervals of 10% without using the clear toner, transferred from the M sheets 53 to T sheets 54, and transferred from the T sheets 54 to special media 55.

Toner images were formed on M sheets 53 by transferring clear toner images having various toner deposition amounts onto fluorescent toner images formed at various print duties, transferred from the M sheets 53 to T sheets 54, and transferred from the T sheets 54 to special media 55. At this time, the print duties varied from 10% to 100% at intervals of 10%, the toner deposition amounts varied in six steps from 0.15 to 0.63 mg/cm², and the toner images were formed by forming a toner image at each combination of print duty and toner deposition amount.

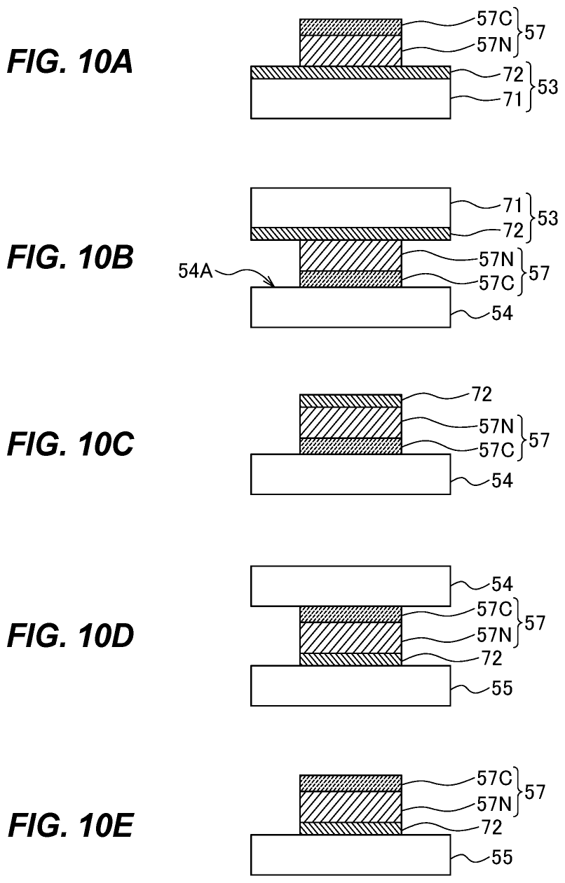

When a clear toner image is placed on a fluorescent toner image, in the special medium printing system 50, as illustrated in FIGS. 10A to 10E, two layers of fluorescent toner and clear toner are stacked on each medium.

Specifically, in the image forming step (see FIG. 2A), as illustrated in FIG. 10A, a fluorescent toner layer 57N and a clear toner layer 57C of a toner image 57 are sequentially stacked on the adhesive layer 72 of the M sheet 53.

In the first transfer step (see FIG. 2B), as illustrated in FIG. 10B, heating and pressing are performed with the clear toner layer 57C of the toner image 57 abutting the surface 54A of the T sheet 54. Further, in the first transfer step, after the M sheet 53 is peeled off, as illustrated in FIG. 10C, the T sheet 54 is in a state where the clear toner layer 57C, fluorescent toner layer 57N, and adhesive layer 72 are sequentially stacked on the surface 54A of the T sheet 54.

Then, in the second transfer step (see FIG. 2C), as illustrated in FIG. 10D, heating and pressing are performed with the adhesive layer 72 abutting a surface of the special medium 55, the fluorescent toner layer 57N and clear toner layer 57C of the toner image 57 stacked on the adhesive layer 72, and the T sheet 54 placed on the toner image 57. Then, in the second transfer step, the T sheet 54 is peeled off, so that the printing process is completed in a state where the adhesive layer 72, fluorescent toner layer 57N, and clear toner layer 57C are sequentially stacked on the surface of the special medium 55 as illustrated in FIG. 10E.

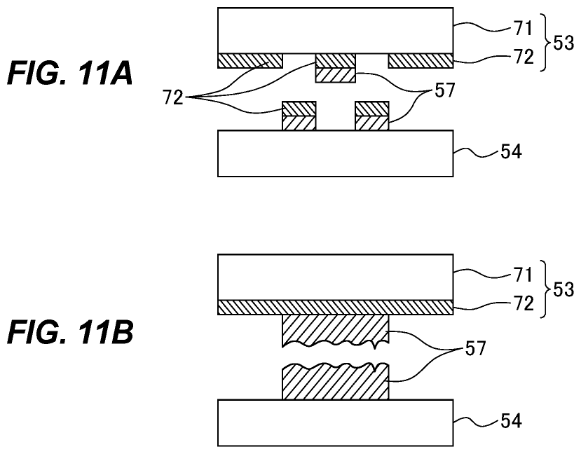

In the gradation measurement, a phenomenon called “toner remaining” occurred depending on conditions. The toner remaining occurred when the toner of the toner image 57 adhered to the adhesive layer 72 of the M sheet 53 but did not sufficiently adhere to the T sheet 54, as illustrated in FIG. 11A, in the first transfer step (see FIG. 2B). It is inferred that the toner remaining occurred because an interface adhesive force between the paper substrate 71 and adhesive layer 72 of the M sheet 53 was greater than an interface adhesive force between the toner of the toner image 57 and the T sheet 54.

When the toner remaining occurred, as the M sheet 53 was peeled off the T sheet 54, part of the toner and adhesive layer was peeled off the T sheet 54 together with the M sheet 53 (i.e., remained on the M sheet 53) and was not transferred onto the T sheet 54. When the toner remaining occurred, the toner in the region where the toner remaining occurred was not transferred onto the special medium 55, so that the image finally transferred on the special medium 55 lacked the toner in the region.

Also, in the gradation measurement, a phenomenon called “toner break” occurred depending on conditions. The toner break is a phenomenon that the toner image 57 sufficiently adheres to both the adhesive layer 72 of the M sheet 53 and the T sheet 54 but breaks (or ruptures) in the thickness direction, as illustrated in FIG. 11B, in the first transfer step (see FIG. 2B). It is inferred that the toner break occurred because a cohesive force between toner particles of the toner constituting the toner image 57 was smaller than each of an interface adhesive force between the toner and the T sheet 54 and an interface adhesive force between the paper substrate 71 and adhesive layer 72 of the M sheet 53.

When the toner break occurred, as the M sheet 53 was peeled off the T sheet 54, a part of the toner was transferred onto the T sheet 54, but the other part of the toner and the adhesive layer 72 were peeled off the T sheet 54 together with the M sheet 53. When the toner break occurred, part of the toner was transferred on the T sheet 54 but the adhesive layer 72 was not transferred on the T sheet 54, which made it impossible for the adhesive layer 72 to adhere the toner to the special medium 55 in the subsequent second transfer step (see FIG. 2C). Thus, the toner in the region where the toner break occurred was not transferred onto the special medium 55, so that the image finally transferred on the special medium 55 lacked the toner in the region.

Based on these facts, for each printing condition, print quality evaluation was made by visually observing the toner transferred on the M sheet 53, the toner transferred on the T sheet 54, and the image finally printed on the special medium (specifically, T-shirt) 55.

Specifically, for each printing condition, the print quality was rated from 1 to 10 in terms of the ratio of the area of portions where toner remaining or toner break occurred to the area of the entire image. A rating of 1 corresponded to cases where the area of portions where toner remaining or toner break occurred was the largest and the print quality was the lowest. A rating of 10 corresponded to cases where neither toner remaining nor toner break occurred and the print quality was the highest. A rating of 8 corresponded to cases where toner remaining or toner break was slightly visually observed but almost invisible (e.g., cases where the ratio of the area of portions where toner remaining or toner break occurred to the area of the image was less than 10%). The rating of 8 will be referred to as the quality level. Ratings of 6 and 7 corresponded to cases where toner remaining or toner break was partially visually observed (e.g., cases where the ratio of the area of portions where toner remaining or toner break occurred to the area of the image was about from 10 to 50%). Ratings of 1 to 5 corresponded to cases where toner remaining or toner break was sufficiently visually observed (e.g., cases where the ratio of the area of portions where toner remaining or toner break occurred to the area of the image was 50% or more).

When the print quality was rated as 8 or more, it was finally evaluated as “excellent”. When the print quality was rated as 6 or 7, it was finally evaluated as “fair”. When the print quality was rated as 5 or less, it was finally evaluated as “poor”.

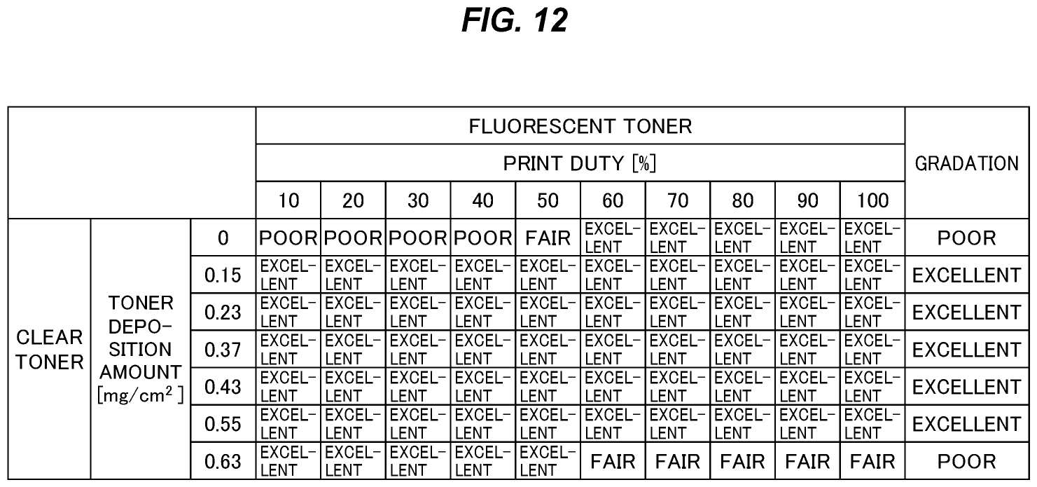

For each fluorescent toner, the evaluation result at each combination of print duty and toner deposition amount of clear toner was as shown in the table of FIG. 12. In FIG. 12, the evaluation results for the cases where the fluorescent toner images were formed at the various print duties without using the clear toner are shown in the row corresponding to a toner deposition amount of clear toner of 0 mg/cm^{2.}

FIG. 12 shows that, in the cases where the printing process was performed using only fluorescent toner and the print duty was 50% or less, the evaluation results were “fair” or “poor”, and the ratings were below the quality level. In these cases, it is inferred that toner remaining occurred.

FIG. 12 shows on the other hand that, in the cases where the print duty was 50% or less but the toner deposition amount of clear toner was 0.15 to 0.63 mg/cm², the evaluation results were “excellent”, and the ratings were at or above the quality level. In these cases, it is inferred that compared to the cases of using only fluorescent toner, placing clear toner increased the toner deposition amount, thereby increasing the interface adhesive force between the toner of the toner image 57 and the surface 54A of the T sheet 54 in the first transfer step (see FIG. 2B) and greatly reducing the amount of toner remaining. In particular, in the first transfer step, as described above, the temperature of the heating surface 63S of the ironing and pressing apparatus 51 was 140° C., which was above the melting temperature (127.8 to 136.5° C.) of each fluorescent toner and far above the melting temperature (97.3° C.) of the clear toner. Thus, it is inferred that, in the first transfer step (see FIG. 10B), the clear toner layer abutting the surface 54A of the T sheet 54 melted more easily than the fluorescent toner layer abutting the adhesive layer 72 of the M sheet 53 and tightly adhered to the T sheet 54, thereby preventing occurrence of toner remaining.

FIG. 12 also shows that, in the cases where the print duty was 60% or more and no clear toner was placed, the evaluation results were “excellent”, and the ratings were at or above the quality level. Further, FIG. 12 shows that, also in the cases where the print duty was 60% or more and the toner deposition amount of clear toner was 0.15 to 0.55 mg/cm², the evaluation results were “excellent”, and the ratings were at or above the quality level.

FIG. 12 shows on the other hand that, in the cases where the print duty was 60% or more and the toner deposition amount of clear toner was 0.63 mg/cm², the evaluation results were “fair”, and the ratings were below the quality level. In these cases, it is inferred that toner break occurred.

Further, for each toner deposition amount of clear toner, it was determined whether the gradation expression was excellent (specifically, whether the rating was at or above the quality level at each print duty). The results were as shown in the rightmost column of FIG. 12, where “excellent” indicates that the gradation expression was excellent and “poor” indicates that the gradation expression was not excellent.

The above gradation measurement shows that, by placing clear toner on a fluorescent toner image at a toner deposition amount of clear toner of 0.15 to 0.55 mg/cm² when a toner image is printed by the image forming apparatus 1, it is possible to provide excellent gradation expression of the fluorescent toner image in the image finally printed on the special medium 55.

### 4-2. Glossiness Measurement

Glossiness measurement was performed as described below. Images were printed on special media 55 at various conditions, and the glossiness of each image was measured using a gloss meter (GM-26D, manufactured by Murakami Color Research Laboratory).

First, the glossiness of an image formed using a fluorescent toner alone was measured. Specifically, a toner image was formed with the fluorescent magenta toner at a print duty of 100% without using the other toners and finally printed on a special medium 55, and the glossiness of the printed image was measured.

Next, the glossinesses of images formed by placing the clear toner on a fluorescent toner were measured. Specifically, toner images were formed using the fluorescent magenta toner and clear toner and finally printed on special media 55, and the glossiness of each of the printed images was measured. Each toner image was formed by forming a fluorescent toner image at a print duty of 100% and placing a clear toner image on the fluorescent toner image. The toner deposition amounts of clear toner of the respective toner images were varied in steps from 0.19 to 0.63 mg/cm².

Further, the glossinesses of images formed by placing a fluorescent white (NW) toner under a fluorescent toner were measured. Specifically, toner images were formed using the fluorescent magenta toner and a fluorescent white toner and finally printed on special media 55, and the glossiness of each of the printed images was measured. Each toner image was formed by forming a fluorescent white toner image and forming a fluorescent toner image at a print duty of 100% on the fluorescent white toner image. The toner deposition amounts of fluorescent white toner of the respective toner images were varied in steps from 0.19 to 0.95 mg/cm².

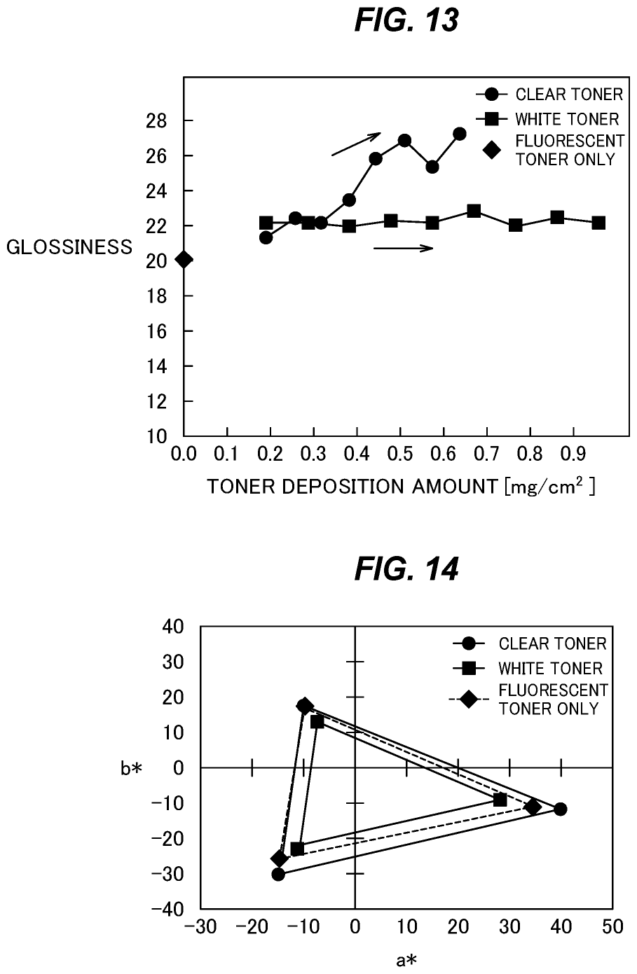

FIG. 13 is a graph showing the glossiness measurement results. FIG. 13 shows the following. Placing the clear (CL) toner and placing the fluorescent white (NW) toner both slightly increase the glossiness compared to the case of using a fluorescent toner alone. In the case of placing the fluorescent white toner, the glossiness is generally constant regardless of the toner deposition amount of fluorescent white toner. On the other hand, in the case of placing the clear toner, when the toner deposition amount of clear toner is relatively small, the glossiness is generally the same as that in the case of placing the fluorescent white toner, but the glossiness increases to a value sufficiently greater than that in the case of placing the fluorescent white toner as the toner deposition amount of clear toner increases.

The above glossiness measurement shows that, by placing clear toner on fluorescent toner when a toner image is printed by the image forming apparatus 1, it is possible to provide glossiness equal to or higher than that in the case of placing fluorescent white toner.

### 4-3. Color Gamut Measurement

Gamut measurement was performed as described below. Images were printed on special media 55 at various conditions, and the hues a* and b* in an L*a*b* color space of each image were measured using an X-Rite 526 (manufactured by X-Rite Inc.).

First, a color gamut in the case of using each fluorescent toner alone was measured. Specifically, for each fluorescent toner, a toner image was formed using the fluorescent toner at a print duty of 50% without using the other toners and finally printed on a special medium 55, and the hues a* and b* of the printed image was measured. Thereby, the color gamut was measured.

Next, a color gamut in the case of placing clear toner on fluorescent toner was measured. Specifically, for each fluorescent toner, a toner image was formed by forming a fluorescent toner image at a print duty of 50% and placing a clear toner image with a toner deposition amount of 0.43 mg/cm² on the fluorescent toner image and finally printed on a special medium 55, and the hues a* and b* of the printed image was measured. Thereby, the color gamut was measured.

Further, a color gamut in the case of placing fluorescent white toner under fluorescent toner was measured. Specifically, for each fluorescent toner, a toner image was formed by forming a fluorescent white toner image with a toner deposition amount of 0.62 mg/cm² and forming a fluorescent toner image at a print duty of 50% on the fluorescent white toner image and finally printed on a special medium 55, and the hues a* and b* of the printed image was measured. Thereby, the color gamut was measured.

FIG. 14 shows the measured color gamut in each case. FIG. 14 shows that, compared to the color gamut in the case of using each fluorescent toner alone, the color gamut in the case of placing fluorescent white (NW) toner under fluorescent toner is narrow, but the color gamut in the case of placing clear toner on fluorescent toner is wide.

### 5. Special Medium Printing Process Based on Measurements

Based on the above measurement results, in the special medium printing system 50, the image forming apparatus 1 is configured to form a toner image by placing clear toner on fluorescent toner in a portion where the amount of the fluorescent toner is relatively small.

When a color toner image is formed on a heat transfer medium, the controller 3 performs control so that a clear toner image is formed on a region where the color toner image is formed and the weight per unit area of the color toner of the color toner image is less than 0.29 mg/cm², and the weight per unit area of the clear toner image is 0.15 to 0.55 mg/cm². The controller 3 may perform control so that no clear toner image is formed on a region where the color toner image is formed and the weight per unit area of the color toner of the color toner image is greater than or equal to 0.29 mg/cm2. When a color toner image is formed on a heat transfer medium, the controller 3 may perform control so that a clear toner image is formed on a region where the color toner image is formed and the weight per unit area of the color toner of the color toner image is less than 0.49 mg/cm², and the weight per unit area of the clear toner image is 0.15 to 0.55 mg/cm². The controller 3 may perform, when the instruction receiver 3A receives a designation of a heat transfer medium, control so that a clear toner image is formed on a region of the heat transfer medium where a color toner image is formed.

Specifically, when the controller 3 (see FIG. 1) of the image forming apparatus 1 receives image data from the host apparatus, the image analyzer 3B analyzes the image data to divide a toner image to be formed based on the image data into multiple regions (referred to below as formation regions) and calculate the toner deposition amount in each formation region. For formation regions where toners of multiple colors are stacked, the image analyzer 3B calculates, as the toner deposition amount, the sum of the toner deposition amounts of the toners of the multiple colors.

The image analyzer 3B then generates bitmap data for clear such that clear toner is placed in formation regions where the calculated toner deposition amount is less than 0.29 mg/cm² and no clear toner is placed in formation regions where the calculated toner deposition amount is 0.29 mg/cm² or more. At this time, the image analyzer 3B generates the bitmap data so that the toner deposition amount of the clear toner is 0.15 to 0.55 mg/cm².

Thereby, the image forming apparatus 1 can form a toner image with a clear toner image superimposed on a fluorescent toner image based on the image data in formation regions where the toner deposition amount of fluorescent toner is relatively small.

### 6. Advantages

When the image forming apparatus 1 forms a color toner image on a heat transfer medium, it places clear toner on a region of the color toner image where the weight per unit area of the color toner image is relatively small (i.e., the color density is relatively low). This can increase the amount of toner per unit area almost without changing the color density expressed by the color toner image. This makes it possible to transfer the toner image from the heat transfer medium onto an intermediate transfer medium without losing toner in the region where the color density is relatively low and transfer the toner image from the intermediate transfer medium onto a special medium to provide a printed image with excellent gradation. Thus, it is possible to provide an image forming apparatus and an image forming method capable of improving image quality of an image transferred on a special medium.

With the above configuration, the image forming apparatus 1 of the special medium printing system 50 according to the embodiment forms a toner image with clear toner placed on a fluorescent toner image based on image data supplied from the host apparatus in formation regions where the amount of fluorescent toner is relatively small, and transfers the toner image onto an M sheet 53 (see FIG. 10A), in the image forming step (see FIG. 2A).

This can sufficiently increase interface adhesive force between the toner image 57 and the T sheet 54 (see FIG. 10B) in the subsequent first transfer step (see FIG. 2B) in the special medium printing system 50. Thereby, in the special medium printing system 50, it is possible to prevent occurrence of toner remaining when the M sheet 53 is peeled off and successfully transfer the toner image 57 and adhesive layer 72 onto the T sheet 54 (see FIG. 10C).

Thus, in the special medium printing system 50, in the subsequent second transfer step (see FIG. 2C), the adhesive layer 72 and toner image 57 in a good condition without toner remaining are transferred onto a surface of a special medium 55 (see FIGS. 10D and 10E). Thus, in the special medium printing system 50, since it is possible to transfer fluorescent toner onto a special medium 55 in portions where the toner deposition amount of fluorescent toner is relatively small, it is possible to provide excellent gradation expression in the portions as well as in portions where the toner deposition amount of fluorescent toner is large.

In particular, in the image forming apparatus 1, the image analyzer 3B of the controller 3 is configured to place clear toner only in formation regions where the sum of the toner deposition amounts of the toners of the respective colors is less than 0.29 mg/cm². Thereby, in the special medium printing system 50, even if the error in the toner deposition amount of clear toner is large and the actual toner deposition amount of clear toner is greater than 0.55 mg/cm² in the image forming apparatus 1, it is possible to certainly prevent occurrence of toner break in an image printed on a special medium 55 (see FIG. 12).

Also, in the image forming apparatus 1, the image analyzer 3B of the controller 3 is configured so that the toner deposition amount of the clear toner is 0.15 to 0.55 mg/cm². Thereby, in the special medium printing system 50, even if the error in the toner deposition amount of fluorescent toner is large and the actual toner deposition amount of fluorescent toner is 0.29 mg/cm² or more in the image forming apparatus 1, it is possible to certainly prevent occurrence of toner break in an image printed on a special medium 55 (see FIG. 12).

Further, the image forming apparatus 1 is configured to place clear toner over fluorescent toner, instead of placing fluorescent white toner under fluorescent toner. Thereby, in the special medium printing system 50, it is possible to increase the glossiness of an image printed on a special medium 55 to a degree equal to or higher than that in the case of placing fluorescent white toner under fluorescent toner (see FIG. 13), and to increase the color gamut as compared to the case of placing fluorescent white toner under fluorescent toner (see FIG. 14).

It is sufficient that clear toner be loaded in the most downstream image forming unit 10 of the image forming apparatus 1 and the image forming apparatus 1 be provided with the image analyzer 3B of the controller 3 configured to perform processes including analysis of image data, calculation of toner deposition amount, and generation of bitmap data for clear. Thus, in the special medium printing system 50, the image forming apparatus 1 can be prepared by preparing a common image forming apparatus including four image forming units corresponding to four colors, loading clear toner in the most downstream image forming unit of the common image forming apparatus, and providing the image analyzer 3B in a controller of the common image forming apparatus. Thus, the image forming apparatus 1 can be produced at an extremely low cost.

With the above configuration, in the special medium printing system 50 according to the embodiment, the image forming apparatus 1 forms a toner image 57 with clear toner placed on fluorescent toner in formation regions where the toner deposition amount of fluorescent toner is less than 0.29 mg/cm², and transfers the toner image 57 onto an M sheet 53, in the image forming step. Thereby, in the special medium printing system 50, it is possible to successfully transfer the toner image 57 and adhesive layer 72 onto a T sheet 54 without causing toner remaining in the subsequent first transfer step and further transfer them onto a special medium 55 in the second transfer step, thereby printing an image with high quality.

### 7. Modifications

The above embodiment places clear toner on fluorescent toner only in formation regions where the toner deposition amount of fluorescent toner (specifically, the sum of the toner deposition amounts of the respective fluorescent toners) is less than 0.29 mg/cm². However, this is not mandatory, and it is also possible to place clear toner on fluorescent toner even in formation regions where the toner deposition amount of fluorescent toner is 0.29 mg/cm² or more, that is, regardless of the toner deposition amount of fluorescent toner. This uniformly places clear toner on an image. This makes it possible to provide uniform gloss, thereby providing high image quality. In this case, it is preferable to make the toner deposition amount of clear toner less than 0.55 mg/cm², thereby preventing toner break.

The above embodiment places clear toner on fluorescent toner when the toner deposition amount is less than 0.29 mg/cm² regardless of the color of the fluorescent toner. However, this is not mandatory. For example, the condition for placing clear toner may be set for each color of fluorescent toner on the basis of the values of the toner deposition amounts shown in FIG. 9. For example, for the fluorescent cyan toner, the condition may be that the toner deposition amount is less than 0.23 mg/cm²; for the fluorescent magenta toner, the condition may be that the toner deposition amount is less than 0.28 mg/cm²; for the fluorescent yellow toner, the condition may be that the toner deposition amount is less than 0.29 mg/cm². For example, when a fluorescent cyan toner image is formed on a heat transfer medium with the fluorescent cyan toner, the controller 3 forms a clear toner image on a region where the fluorescent cyan toner image is formed and the weight per unit area of the cyan toner is less than 0.23 mg/cm². When a fluorescent magenta toner image is formed on a heat transfer medium with the fluorescent magenta toner, the controller 3 forms a clear toner image on a region where the fluorescent magenta toner image is formed and the weight per unit area of the magenta toner is less than 0.28 mg/cm². When a fluorescent yellow toner image is formed on a heat transfer medium with the fluorescent yellow toner, the controller 3 forms a clear toner image on a region where the fluorescent yellow toner image is formed and the weight per unit area of the yellow toner is less than 0.29 mg/cm².

Further, the above embodiment places clear toner on fluorescent toner so that the toner deposition amount of the clear toner is less than 0.55 mg/cm². However, this is not mandatory. For example, in formation regions where the toner deposition amount of fluorescent toner (specifically, the sum of the toner deposition amounts of the respective fluorescent toners) is less than 0.29 mg/cm², the toner deposition amount of clear toner may be 0.55 mg/cm² or more. In short, it is preferable to place clear toner on fluorescent toner without causing toner break.

Further, in the above embodiment, the image forming apparatus 1 transfers a toner image 57 with clear toner placed over (or on the upper side of) fluorescent toner onto an M sheet 53 in the image forming step (see FIGS. 2A and 10A). However, this is not mandatory. For example, it is possible to transfer a toner image 57 with clear toner placed under (or on the lower side of) fluorescent toner onto an M sheet 53. Thus, it is possible to transfer a toner image 57 with clear toner placed under fluorescent toner onto a special medium 55.

Further, in the above embodiment, the image forming apparatus 1 forms a toner image by using the fluorescent toners (specifically, the fluorescent cyan toner, fluorescent yellow toner, and fluorescent magenta toner) as toners (referred to below as color toners) other than the clear toner. However, this is not mandatory. For example, it is possible to form a toner image by using color toners consisting of toners of common colors, such as cyan toner, yellow toner, and magenta toner. In this case, the number of color toners used is not limited to three, and may be two or less or four or more. Also, a combination of one or more toners of common colors and one or more fluorescent toners may be used as color toners.

Further, in the above embodiment, the release surface 71A is formed by coating a surface of the paper substrate 71 with a release agent (see FIG. 3A). However, this is not mandatory. For example, when the material constituting the paper substrate 71 has properties allowing the adhesive medium (i.e., adhesive layer 72) to be easily peeled off, the release surface 71A may be formed without coating with a release agent.

Further, in the above embodiment, in the adhesive layer 72 of the M sheet 53, the abutment surface 72B has larger surface roughness than the toner transfer surface 72A (see FIGS. 4A and 4B). However, this is not mandatory. For example, the toner transfer surface 72A and abutment surface 72B may have the same surface roughness. Also, the adhesive layer 72 need not necessarily have a thickness of 40.0 μm, and may have other thicknesses. However, in view of conveyability of the M sheet 53 in the image forming apparatus 1, transfer and adhesion of the toner image 57 to the special medium 55 by the ironing and pressing apparatus 51, and the like, the adhesive layer 72 preferably has a thickness of 20 to 80 μm, and the M sheet 53 preferably has a total thickness of 100 to 160 μm. Further, the adhesive layer 72 need not necessarily be lipophilic.

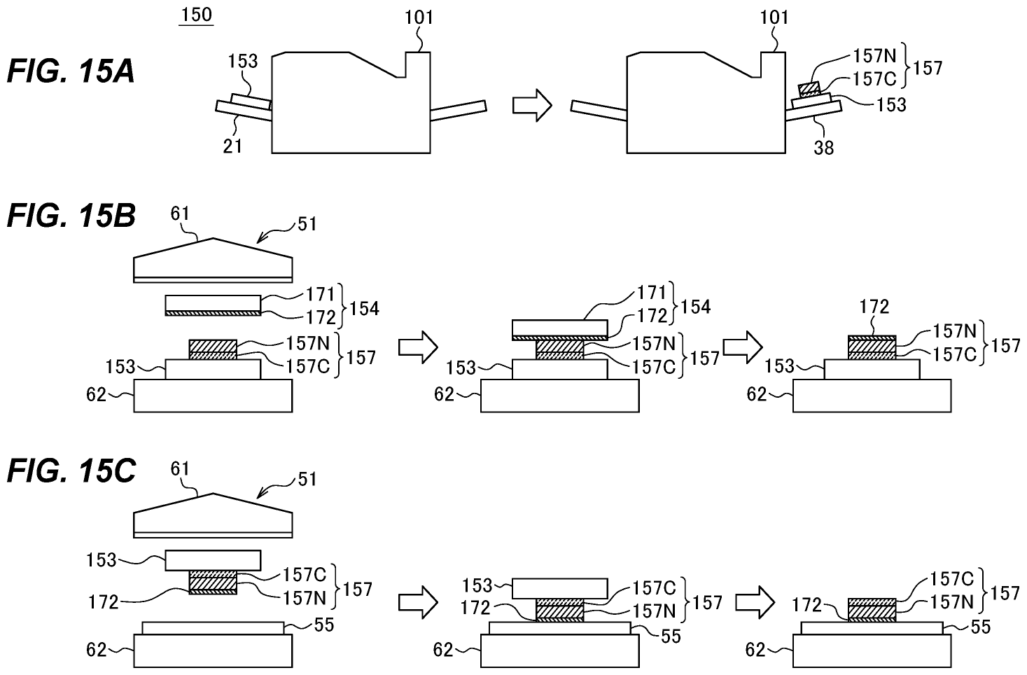

Further, in the above embodiment, the M sheet 53 including the paper substrate 71 and the adhesive layer 72 laminated on the paper substrate 71 is used (see FIG. 3), and the image forming apparatus 1 forms a toner image 57 and transfers it onto the M sheet 53 in the image forming step (see FIG. 2A). However, this is not mandatory. For example, as in a special medium printing system 150 illustrated in FIGS. 15A to 15C, corresponding to FIGS. 2A to 2C, a transfer paper sheet 153 and an adhesive medium 154 may be used instead of the M sheet 53 and T sheet 54.

The transfer paper sheet 153 is, for example, Laser-Dark A-Foil (manufactured by Forever). The transfer paper sheet 153 has a configuration similar to that of the T sheet 54, and has no adhesive layer. On the other hand, the adhesive medium 154 is, for example, Laser-Dark B-Paper (manufactured by Forever). The adhesive medium 154 has a configuration similar to that of the M sheet 53, and has a paper substrate 171 and an adhesive layer 172 laminated on the paper substrate 171.

In the special medium printing system 150, an image forming step (see FIG. 15A) is performed by an image forming apparatus 101 instead of the image forming apparatus 1, and then a first transfer step (see FIG. 15B) and a second transfer step (see FIG. 15C) are sequentially performed by the ironing and pressing apparatus 51.

Unlike in the image forming apparatus 1, in the image forming apparatus 101, an image forming unit 10 that forms a clear toner image is disposed most upstream. Thus, in the special medium printing system 150, in the image forming step (see FIG. 15A), when a toner image 157 is formed on a transfer paper sheet 153 by the image forming apparatus 101, a clear toner layer 157C is formed directly on the transfer paper sheet 153 and a fluorescent toner layer 157N is placed on the upper side of the clear toner layer 157C. At this time, similarly to the image forming apparatus 1, the image forming apparatus 101 places clear toner in formation regions where the toner deposition amount is less than 0.29 mg/cm².

Then, in the special medium printing system 150, in the first transfer step (see FIG. 15B), an adhesive medium 154 is placed on the upper side of the transfer paper sheet 153 with the adhesive layer 172 abutting the toner image 157, and the ironing and pressing apparatus 51 performs a press process of applying heat and pressure at a temperature of 160° C. and a pressure of 37.5 psi for 120 s. Then, the adhesive medium 154 is peeled off, thereby placing the transfer paper sheet 153 in a state where the adhesive layer 172 adheres to the toner image 157.

Then, in the special medium printing system 150, in the second transfer step (see FIG. 15C), the transfer paper sheet 153 is inverted and placed on a special medium 55 with the adhesive layer 172 abutting the special medium 55, and the ironing and pressing apparatus 51 performs a press process of applying heat and pressure at a temperature of 160° C. and a pressure of 37.5 psi for 30 s. Then, the transfer paper sheet 153 is peeled off, thereby placing the special medium 55 in a state where the toner image 157 is adhered to the special medium 55 by the adhesive layer 172 and the clear toner layer 157C is placed above the fluorescent toner layer 157N. In this manner, in the special medium printing system 150, it is possible to print an image with excellent gradation expression on the special medium 55 using the transfer paper sheet 153 and adhesive medium 154. Further, in the above embodiment, an image is finally printed on a T-shirt as a special medium 55 (see FIGS. 2A to 2C). However, this is not mandatory. For example, it is possible to print an image on special media, such as fabric bags or curtains, made of various materials to which the adhesive layer 72 can adhere when heated and pressed by the ironing and pressing apparatus 51.

Further, in the above embodiment, the image forming apparatus 1 is of a direct transfer system, and configured to transfer toner images from the photosensitive drums 14 of the image forming units 10 directly onto a sheet P (see FIG. 1). However, this is not mandatory. For example, the image forming apparatus 1 may be of an intermediate transfer system (or two-step transfer system), and configured to sequentially transfer toner images of different colors from the photosensitive drums 14 of the image forming units 10 onto an intermediate transfer belt in a superimposed manner and transfer the toner images from the intermediate transfer belt onto a sheet P.

Further, in the above embodiment, the image forming apparatus 1 includes the four image forming units 10 (see FIG. 1). However, this is not mandatory. For example, the image forming apparatus 1 may include three or less or five or more image forming units 10.

Further, in the above embodiment, the present invention is applied to the image forming apparatus 1 that is a single function printer. However, this is not mandatory. For example, the present invention is applicable to other image forming apparatuses having various functions, such as multi-function peripherals (MFPs) having copy and facsimile functions.

Further, the present invention is not limited to the above embodiment and modifications. The present invention also covers embodiments obtained by combining some or all of the above embodiment and modifications, embodiments obtained by combining parts of the above embodiment and modifications, and embodiments obtained by extracting part of the above embodiment and modifications. The present invention can be practiced in various other aspects without departing from the inventive scope.

Further, in the above embodiment, the image forming apparatus 1 as an image forming apparatus is constituted by the image forming unit 10CL as a first image forming unit, the image forming units 10NC, 10NY, and 10NM as second image forming units, the transfer belt 28 and transfer rollers 29 as a transfer unit, and the controller 3 as a controller. However, this is not mandatory. An image forming apparatus may be constituted by a first image forming unit, a second image forming unit, a transfer unit, and a controller that have other configurations.

The present invention can be used when an image is printed on a special medium by using an electrophotographic image forming apparatus.

What is claimed is:

1. An image forming apparatus comprising:
a first image forming unit that forms a clear toner image with a clear toner;
a second image forming unit that forms a color toner image with a color toner;
a transfer unit that transfers at least one of the clear toner image and the color toner image onto a medium; and
a controller that controls formation of the clear toner image and the color toner image,
wherein when the medium is a heat transfer medium and the color toner image is formed on the heat transfer medium, the controller performs control so that the clear toner image is formed on a region where the color toner image is formed and a weight per unit area of the color toner is less than 0.29 mg/cm², and a weight per unit area of the clear toner image is 0.15 to 0.55 mg/cm².

2. The image forming apparatus of claim 1, wherein when the color toner image is formed on the heat transfer medium, the controller performs control so that no clear toner image is formed on a region where the color toner image is formed and the weight per unit area of the color toner is greater than or equal to 0.29 mg/cm².

3. The image forming apparatus of claim 1, wherein when the color toner image is formed on the heat transfer medium, the controller performs control so that the clear toner image is formed on a region where the color toner image is formed and the weight per unit area of the color toner is less than 0.49 mg/cm², and the weight per unit area of the clear toner image is 0.15 to 0.55 mg/cm².

4. The image forming apparatus of claim 1, wherein the controller places the color toner image and the clear toner image in this order on the heat transfer medium.

5. The image forming apparatus of claim 1, wherein the heat transfer medium includes a substrate having a transfer surface that is a side on which the color toner image or the clear toner image is transferred, and an adhesive layer formed on the transfer surface.

6. The image forming apparatus of claim 5, wherein the adhesive layer has a toner transfer surface on which the color toner image or the clear toner image is transferred, and a substrate abutment surface abutting the substrate, and the substrate abutment surface has a greater surface roughness than the toner transfer surface.

7. The image forming apparatus of claim 5, wherein the adhesive layer is made of a lipophilic material.

8. The image forming apparatus of claim 5, wherein the adhesive layer has a thickness of 20 to 80 μm.

9. The image forming apparatus of claim 5, wherein the transfer surface of the substrate is coated with a release agent.

10. The image forming apparatus of claim 5, wherein the heat transfer medium has a thickness of 100 to 160 μm.

11. The image forming apparatus of claim 1, wherein the color toner is a fluorescent toner containing a fluorescent pigment or a fluorescent brightener.

12. The image forming apparatus of claim 1, wherein the color toner is a fluorescent cyan toner, and
wherein when a fluorescent cyan toner image is formed on the heat transfer medium with the fluorescent cyan toner, the controller forms the clear toner image on a region where the fluorescent cyan toner image is formed and a weight per unit area of the cyan toner is less than 0.23 mg/cm².

13. The image forming apparatus of claim 1, wherein the color toner is a fluorescent magenta toner, and
wherein when a fluorescent magenta toner image is formed on the heat transfer medium with the fluorescent magenta toner, the controller forms the clear toner image on a region where the fluorescent magenta toner image is formed and a weight per unit area of the magenta toner is less than 0.28 mg/cm².

14. The image forming apparatus of claim 1, wherein the color toner is a fluorescent yellow toner, and
wherein when a fluorescent yellow toner image is formed on the heat transfer medium with the fluorescent yellow toner, the controller forms the clear toner image on a region where the fluorescent yellow toner image is formed and a weight per unit area of the yellow toner is less than 0.29 mg/cm².

15. The image forming apparatus of claim 1, wherein the controller includes a type designation receiver that receives designation of a type of the medium, and when the type designation receiver receives a designation of the heat transfer medium, performs control so that the clear toner image is formed on a region of the heat transfer medium where the color toner image is formed.

16. An image forming method comprising:
(a) forming a toner image and transferring the toner image onto an adhesive layer of a heat transfer medium, with an image forming apparatus;
(b) transferring the toner image and the adhesive layer onto an intermediate transfer medium by applying heat and pressure with a heating and pressing apparatus in a state where the heat transfer medium is placed on the intermediate transfer medium with the toner image therebetween; and
(c) transferring the toner image and the adhesive layer onto a special medium by applying heat and pressure with the heating and pressing apparatus in a state where the intermediate transfer medium is placed on the special medium with the toner image and the adhesive layer therebetween,
wherein step (a) includes:
forming a clear toner image with a clear toner and forming a color toner image with a color toner by means of an image forming unit under control of a controller provided in the image forming apparatus; and
transferring at least one of the clear toner image and the color toner image onto the heat transfer medium by means of a transfer unit, and
wherein the controller performs control so that the clear toner image is formed on a region where the color toner image is formed and a weight per unit area of the color toner is less than 0.29 mg/cm², and a weight per unit area of the clear toner image is 0.15 to 0.55 mg/cm².
